(19) United States
(12) Patent Application Publication
(10) Pub. No.: US 2002/0133614 A1
(43) Pub. Date: Sep. 19, 2002

(54) System and method for remotely estimating bandwidth between internet nodes

(76) Inventors: Samaradasa Weerahandi, Pittstown, NJ (US); Yu-Yun K. Ho, Basking Ridge, NJ (US); John Kettenring, Summit, NJ (US); Ricardo Matija, East Brunswick, NJ (US); Sunil Madhani, Morristown, NJ (US); Arnold Neidhardt, Middletown, NJ (US); Thomas Spacek, Flemmington, NJ (US)

Correspondence Address: William A. Schoneman, Esq., Telcordia Technologies, Inc., 445 South Street, Room 1G112R, Morristown, NJ, 07960, US

(21) Appl. No.: 09/773,839

(22) Filed: Feb. 1, 2001

(51) Int. Cl. G06F 15/16

(52) U.S. Cl. 709/237

(57) ABSTRACT

A communications network monitoring system and method remotely determines the total bandwidth between any two nodes on the network as well as the available bandwidth between nodes at a given time. A remote host sends data packets to each of the two nodes. A reply is sent back to the remote host generating a delay time. A set of delay times for data packets of various sizes is generated at the host. The data set is then analyzed using a robust estimation method and a Bayesian analysis to determine the total bandwidth and the mean delay between the two nodes. Moreover, the available bandwidth for a time, t, can be estimated by first injecting traffic into the network from a remote traffic generator to develop an estimate of the traffic and a router characteristic parameter, γ. This constant and a Bayesian estimate of the α(t) are used to estimate the available bandwidth at any given time t.

### BACKGROUND OF THE INVENTION

The present invention relates generally to estimating the bandwidth of links in a communications network, particularly the Internet, and more particularly to remotely estimating the total bandwidth and available bandwidth as a function of time for any link between two nodes.

The number of people seeking to browse the World Wide Web (“WWW”), send e-mail or make telephone calls using the Internet continues to increase. Increasing the bandwidth available on the Internet to be able to meet increasing demand for these services in addition to demand for streaming audio and video has been the impetus for a continual build-out of the Internet infrastructure. As the number of bandwidth providers increases, the importance of being able to value bandwidth becomes increasingly important. Therefore, a way to estimate the total bandwidth and bandwidth usage over time between two locations or nodes on the Internet is necessary in order to determine both the availability and value of such bandwidth.

Finding the bandwidth between nodes on the Internet also becomes important in many Internet related studies such as Network Performance Monitoring and Measurement (“NPMM”). Such a method can be used for Internet traffic monitoring (by integrating measured bandwidth over time) and proactive network management.

The estimation of the available bandwidth for any instant in time must be completed before the estimation is no longer valid. In other words, the computational overhead of the estimation method must not be so great as to prohibit a solution within a useful period of time.

The method should enable the estimation of available bandwidth from a remote location because direct access to the node or nodes being tested may be prohibited or impossible.

The method should also not prohibitively add to the amount of traffic on the Internet.

One method of bandwidth-related measurement is based on “TREno” and is described in “Empirical Bulk Transfer Capacity” by Matt Mathis. In TREno UDP packets with increasing TTL (Time To Live) are sent along the path from the server to the invoking client. The result obtained from TREno, however, is the TCP-based throughput from monitoring point to test point and not bandwidth of remote link. Additionally, TREno requires at least 10 seconds of continuous traffic resulting in significant overhead and delay.

Another method of bandwidth determination is “bing” which computes the point to point throughput using two sizes of ICMP ECHO_REQUEST packets to a pair of remote hosts. Bing imposes a significant load on the network and cannot be used during normal operations.

The “Bprobe” and “Cprobe” techniques measure the bottleneck bandwidth and available bandwidth between two hosts on a network. As with TREno, however, the throughput is from a monitoring point to a test point not the bandwidth of a remote link.

Pathchar collects RTT (Round Trip Times) values between a source node and every intermediate router by changing the value of the TTL field. Pathchar uses that data to provide estimates of bandwidth between Internet links. It does not, however, provide a measure of the bandwidth available at a specific time. The use of statistical methods to improve bandwidth estimation using Pathchar has been proposed by Matoba, et al. In a paper entitled “Improving Bandwidth Estimation for Internet Links by Statistical Methods.” Again, however, the method does not enable the measurement of the available bandwidth at a specific time.

Therefore, it is desirable to provide a system and method for remotely estimating the total bandwidth and the bandwidth available at any point in time between any two locations or nodes on the internet using minimal computation time and injecting little additional network traffic.

Additional objectives, features and advantages of the invention will be set forth in the description that follows, and in part will be apparent from the description, or may be learned by practice of the invention. The objectives and other advantages of the invention will be realized and attained by means of the instrumentalities and combinations particularly pointed out in the written description and appended claims hereof as well as the appended drawings.

### SUMMARY OF THE INVENTION

Methods and systems consistent with the present invention remotely estimate the bandwidth available between any two nodes in the Internet or other network.

To achieve the objects and in accordance with the purposes of the invention, as embodied and broadly described herein, the invention comprises a method of remotely estimating the bandwidth between two nodes in a network comprising the step of generating a plurality of randomly-sized data packet pairs each having a first data packet and a second data packet of equivalent size, the step of sending each of the first data packets to a first node and sending each of the second data packets to a second node; generating a set of first delay times indicative of the time each of the first data packets required to reach the first node; generating a set of second delay times indicative of the time each of the second data packets required to reach the second node and estimating the total bandwidth based on said set of first delay times and said second delay times.

The method further enables a user to estimate the available bandwidth at a time, t, by determining a traffic and router parameter by injecting a known quantity of traffic into the network from a point remote to the bandwidth estimator. The estimation of the traffic and router parameter is combined with the delay data described above to generate an estimation of the available bandwidth.

A system is also disclosed having a memory for storing an operating system and a bandwidth estimator program, a processor in communication with said memory for executing instructions from said operating system and said bandwidth estimator program and a network interface for sending and receiving data to and from said nodes in said communications network. The bandwidth estimator generates a plurality of randomly-sized data packet pairs each having a first data packet and a second data packet of equivalent size, sends said plurality of said first data packets to said first node through the network interface, sends said plurality of said second data packets to said second node through the network interface, receives response messages through the network interface from the respective nodes, generates a set of first delay times indicative of the time each of said first data packets required to reach said first node, generates a set of second delay times indicative of the time each of said second data packets required to reach said second node and estimates the total bandwidth based on said set of first delay times and said second delay times. The system may also include a traffic generator for generating and injecting a known quantity of traffic into said network at a location remote from said network interface. The bandwidth estimator may also include a means for estimating the traffic and router characteristic parameters (γ) and the available bandwidth as a function of time based on said set of first delay times and said second delay times and the average available bandwidth for a short period of time.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate presently preferred implementations of the invention and, together with the general description given above and the detailed description of the preferred implementations given below, serve to explain the principles of the invention.

In the drawings,

FIG. 1 is a diagram of an Internet network;

FIG. 2 is a diagram depicting the measured round trip delay for packets of increasing size;

FIG. 3 is a flow diagram illustrating a method of remotely estimating the total bandwidth between two nodes in a network; and

FIG. 4 is a flow diagram illustrating a method of remotely estimating the available bandwidth over time between two nodes in a network;

FIG. 5 is schematic diagram of a system for measuring estimated total and/or available bandwidth according to the present invention.

### DETAILED DESCRIPTION OF THE INVENTION

Reference will now be made in detail to the construction and operation of preferred implementations of the invention illustrated in the accompanying drawings. Wherever possible, the same reference numbers will be used throughout the drawings to refer to the same or like parts. The following description of the preferred implementations of the present invention is only exemplary of the invention. The present invention is not limited to these implementations, but may be realized by other implementations.

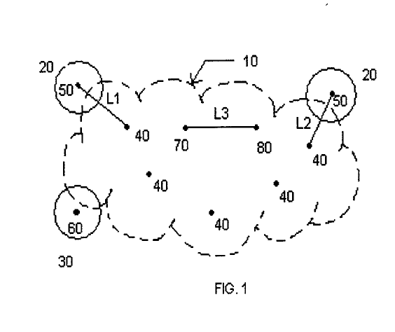

Referring to FIG. 1 cloud 10 depicts an amorphous network such as the Internet in which data is communicated to and from service providers 20 and system end-users 30 through one or more routers 40. Data is sent from a server 50 over a path comprising one or more routers 40 with such data being received by another server 50 or by the remote monitor host 60 of system end-user 30. A node in such a network could be a server 50, a router 40, a workstation of a remote monitor host 60 or a modem in a modem bank belonging to a certain service provider. In the present invention it is only necessary to know the Internet Protocol (IP) address of each of the end point nodes 70 and 80 of the hop. The communications medium between nodes can be any medium such as Ethernet, Fiber Distributed Data Interface (“FDDI”), Asynchronous Transfer Mode (“ATM”) or any Internet Protocol (IP) medium such as Internet Protocol—Virtual Private Network (“IP—VPN”).

The present method and system determines the bandwidth between any two nodes in such a network by taking various delay measurements from the remote monitor host 60 to the end points 70 and 80 of the hop for varying packet sizes. The resulting data is then statistically analyzed to provide the result. For example, in remotely measuring available bandwidth of a link L located on Internet with end-point nodes 70 and 80 respectively being the nodes of the link L, the IP address of each node 70 and 80 must be known. Packets of data are sent from the remote host to each node 70 and 80. The data consists of different packet sizes resulting in varying corresponding delay. It is also assumed that the data packets first reach node 70 and then node 80. In order to measure delay an Internet Control Management Protocol (ICMP) Echo Request Packet is sent to node 70 and the remote host awaits for the ICMP Echo Reply Packet. Transmission and reception of Echo Request and Echo Reply is timed and the difference gives us the round trip delay. Similarly, the round trip delay for node 80 is measured. Both nodes 70 and 80 must be ICMP enabled, i.e., each must accept ICMP packets.

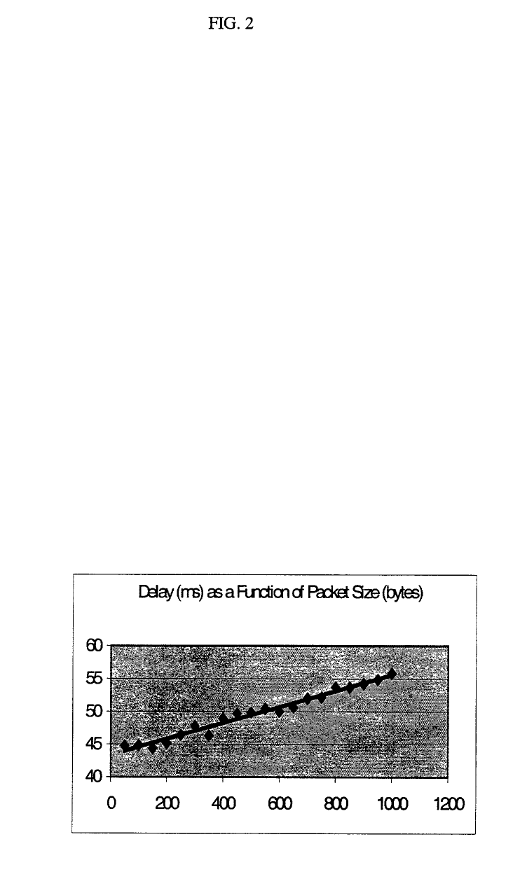

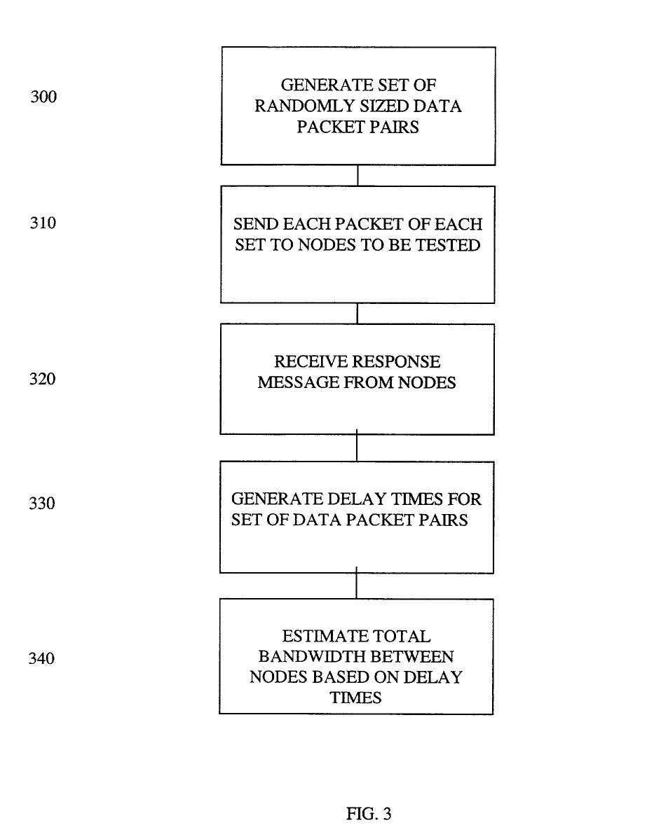

With Reference to FIG. 3, ICMT Echo Request packets of various sizes are randomly selected in Step 300 to generate a set of values ranging from 100 bytes to 1000 bytes. It is not desirable to send data packets in size order, rather, the sizes should be selected randomly. In step 310 the data packets are sent to nodes 70 and 80. The round trip delay is computed after the receipt of the corresponding ICMP Echo Reply packet in step 320, thus generating a set of data consisting of packet sizes and corresponding delay for nodes 70 and 80 in step 330. In the same way, a set of data consisting of data sizes and corresponding delay if generated for node 80. FIG. 2 is a diagram depicting the round trip minimum delay for packets of increasing size. This is the case for both nodes 70 and 80, and the delay up to node 80 tends to be larger than the delay up to node 70, but for any given set of measurements this may not necessarily be the case due to network jitter.

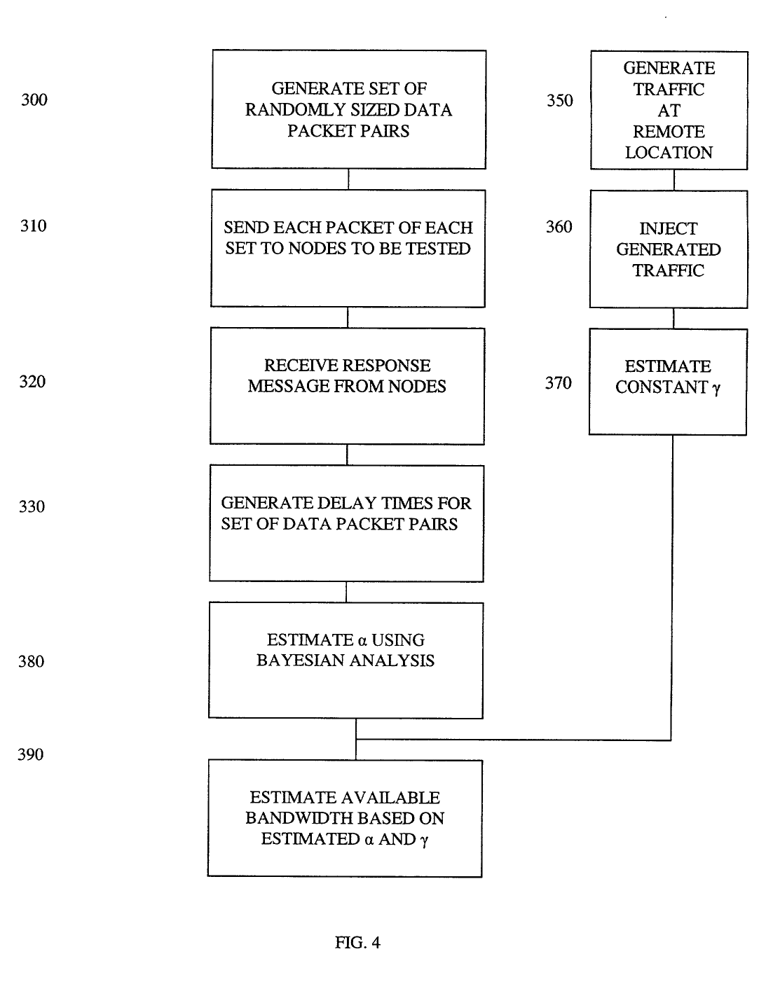

The final step 340 of the method of the present invention is to estimate total bandwidth and also at step 390 of FIG. 4 the available bandwidth at any given time for any given link between two nodes in the network. If there are n links between the monitoring and the destination nodes, the one way delay contributed by the i^{th} hop can be written as

d^{(t)}=d_{q}^{(t)}+dₚ⁽ⁱ⁾+dₗ^{(t)}+(8·10⁻⁶·s)/C⁽ⁱ⁾ (1)

where d_{q}⁽ⁱ⁾ is the router queuing delay in seconds, dₚ⁽ⁱ⁾ is the router processing delay in seconds, dₗ⁽ⁱ⁾ is the link length dependent delay in seconds, which is equal to length of the link divided by the speed of the transmission medium with the maximum being the speed of light, s denotes the packet size in bytes, and C⁽ⁱ⁾ is the bandwidth in megabits per second.

Collecting terms that do not depend on the packet size, the equation becomes

d⁽ⁱ⁾=α⁽ⁱ⁾+β⁽ⁱ⁾s, (2)

where α^{(t)}=d_{q}^{(t)}+dₚ⁽ⁱ⁾+dₗ⁽ⁱ⁾ and β⁽ⁱ⁾=(8·10⁻⁶)/C⁽ⁱ⁾.

The term α⁽ⁱ⁾ is, therefore, the total packet-size independent delay based on the sum of the router queuing delay, router processing delay and link length dependent delay for the i^{th} link. The term β⁽ⁱ⁾ is the delay per byte to the i^{th} link.

FIG. 2 shows the results of an actual experiment measuring the delay under varying packet size. Notice that these empirical results are in agreement with Equation (2).

According to Equation (2), upon the estimation of β⁽ⁱ⁾ the bandwidth can be estimated as

$${C}^{( i )} = \frac{8 \cdot {10}^{- 6}}{{β}^{( i )}} . \qquad ( 3 )$$

However, d^{(t)} is not directly observable so in its place two sets of observable measurements are used to estimate β^{(t)}. Let D⁽ⁱ⁾ denote the round trip delay time in seconds from the monitoring node to the i^{th} link. One-way delay is approximately half of the round trip delay and the difference between the two quantities, say the residual, have no specific sign regardless of whether the packets take the same path or not. Then

$${D}^{( i )} = {\sum }_{j = 1}^{i} 2 {d}^{( j )} + e = {\sum }_{j = 1}^{i} 2 {α}^{( j )} + {\sum }_{j = 1}^{i} 2 {β}^{( j )} s + e ,$$

where e is the residual error term which is assumed to have a statistically symmetric distribution with zero mean. By sending packets of the same size consecutively to the (i−1)^{th} and the i^{th} link, subtract D⁽ⁱ⁻¹⁾ from D⁽ⁱ⁾ and divide the difference by 2 and the result is Equation (2). From this point on, denote

$$\frac{{D}^{( i )} - {D}^{( i - 1 )}}{2}$$

by DD and the observed value by dd. Data is collected by sending 2 packets each having the same randomly chosen size to the (i−1)^{th} and the i^{th} links and recording DD. The same process is repeated within a very short period of time for m times. Therefore,

DDₖ=α+βsₖ+εₖ,k=1, . . . , m, (4)

where εₖ is some random error.

It is conceivable that α and β depend on time, but since the m samples are collected within several milliseconds, they can be treated as constants for that short period of time. Estimating α and β is seemingly straightforward. Ordinary Least Square (“OLS”) could be used to estimate them. This may not be sufficiently accurate, however, due to the possibly non-normal nature of the error distribution. Moreover, due to network noise, it is possible that some of the DDₖs turn out to be negative and in such a case OLS could give negative estimates for α and β.

The preferred method of the present invention is to use the following estimation scheme for α and β. First, a robust regression method such as the Least Trimmed Squares (“LTS”) estimation is used to obtain a pair of initial estimates \hat{α}⁰ and \hat{β}⁰. Then assuming that β is known, α is estimated using a Bayesian method, which provides more accurate estimates when some of the data can be negative. The process can be repeated for convergence of the estimates if higher degree of accuracy is desired. LTS and other robust regression techniques down-weights outliers by minimizing the weighted sum of the squared residuals. For example, in LTS the initial set of estimates for α and β is given by

$$( {\hat{α}}^{0} , {\hat{β}}^{0} ) = {a r g min}_{α , β} {\sum }_{i = 1}^{q} ( {r}_{( j )}^{2} ( α , β ) ) \qquad ( 5 )$$

where r₍ⱼ₎² (α,β) is the j^{th} ordered statistics of the squared residuals.

When the link in question is many hops away from the remote host, the accuracy can be substantially increased by taking a number of observations for each packet size and then basing the parameter estimation on the minimum delay obtained at each packet size. Note that only the α term is affected by this and so β can be estimated with the model

DDMinₖ=αₘᵢₙ+βsₖ+εₖ,k=1, . . . , M (6)

where M is the distinct number of packets sizes used and

$$D D Min = min \frac{{D}^{( i )}}{2} - min \frac{{D}^{( i - 1 )}}{2}$$

observed at a given packet size. In application of DDmin, data residuals, ε, in this model tend to be more normal thus increasing the accuracy of the estimates. Similarly robust estimation methods can be employed to estimates of β⁽ⁱ⁾ and β⁽ⁱ⁻¹⁾ as needed.

Estimation of total delay due to i^{th} hop and available bandwidth at a given time, in turn requires estimation of the parameters in Equation (2). Now, setting β=\hat{β}⁰, the original α=α⁽ⁱ⁾−α⁽ⁱ⁻¹⁾, which is important in making inferences concerning parameters of i^{th} hop, can be estimated using all raw data, equation (4), and a Bayesian approach. Working with all raw data as opposed to DDMin data, the assumption of normally distributed residuals is not at all reasonable, because the distribution of α⁽ⁱ⁾+ε is highly right-skewed and takes on only positive values. As a result, application of classical estimation methods including robust methods would lead to inaccurate and even negative estimates, because they are typically designed to estimate only location parameters rather than all parameters that characterize the distribution. According to the literature on the distribution of delay data, the assumption of an inverse Gaussian distribution is more reasonable. Our approach works with any delay distribution, but for the purpose of illustrating our approach, it is assumed that the delay contributed by each link has an inverse Gaussian distribution. Moreover, non-informative prior knowledge on parameters α and its standard deviation σ is assumed. To describe the estimation procedure, consider, for instance the problem of estimating α^{(t)}, given the data and the estimate of β⁽ⁱ⁾. Suppressing the super scripts, the joint posterior distribution for the unknown parameters given d=(d₁, d₂, . . . , dₘ) is found as

$$L ( α , σ \vert {\hat{β}}^{0} , {d}_{\sim} ) = {\prod }_{i = 1}^{m} \frac{1}{\sqrt{2 πσ}} {( \frac{μ}{{d}_{i}} )}^{\frac{3}{2}} {e}^{- \frac{1}{2 {σ}^{2}} \frac{μ}{{d}_{i}} {( {d}_{i} - μ )}^{2}} \qquad ( 7 )$$

where μ=α+\hat{β}⁰s.

The Bayesian point estimate for α is given by the posterior expectation

$$\hat{α} = E ( α \vert {\hat{β}}^{0} , {d}_{\sim} ) = \frac{{\int }_{0}^{∞} {\int }_{0}^{∞} α L ( α , σ \vert {\hat{β}}^{0} , {d}_{\sim} ) ⅆ σ ⅆ α}{{\int }_{0}^{∞} {\int }_{0}^{∞} L ( α , σ \vert {\hat{β}}^{0} , {d}_{\sim} ) ⅆ σ ⅆ α} \qquad ( 8 )$$

The σ parameter can be similarly estimated to describe the complete distribution of α+ε, which is important for instance in making confidence statements about the delay due to a particular hop of interest. The \hat{α} is a parameter necessary in estimating the hop delay and available bandwidth in step 380 of FIG. 4. The estimated total bandwidth in step 340 of FIG. 3 is computed as

$$\frac{8 \cdot {10}^{- 6}}{{\hat{β}}^{( 0 )}} .$$

The second objective of the present invention is to provide method and apparatus to estimate available bandwidth A(t) (and hence also the used bandwidth) at any given time t, that is the additional megabits of traffic that can be transmitted through the link per second on average during a small time interval around time t. In the previous estimation method, it was assumed that α and β are constants, because the m samples are collected within a matter of several milliseconds. Depending on time of day, the estimated values as well as actual value of α will be different. Therefore, indexing them by time they become α(t) and β(t).

Until the link is changed total bandwidth and hence β(t) is a constant so that β(t)=β. In fact, a noticeable structural change occur in the estimated bandwidth β is best estimated using all historical data and it is only the available bandwidth that need to be estimated using data collected during a small time interval.

From empirical data, it was found that the available bandwidth can be well approximated by mean throughput (packet size divided by delay) with certain value in place of the packet size. Using β in place of β(t), throughput is computed as

$$T h P = \frac{8 \cdot s \cdot {10}^{- 6}}{mean ( D D )} = \frac{8 \cdot s \cdot {10}^{- 6}}{α ( t ) + s β} = \frac{8 \cdot {10}^{- 6}}{α ( t ) / s + β} \qquad ( 9 )$$

As packet size, s increases ThP increases to the asymptote total bandwidth. But s cannot be increased arbitrarily because with large s, packets get fragmented and the underlying equations will no longer be valid. According to empirical data, if used bandwidth is defined as the average megabits of traffic per second that pass through the link during a short interval around t, then there is a time-independent s* such that ThP evaluated at s*≈A(t), i.e.,

$$A ( t ) \approx \frac{8 \cdot {10}^{- 6}}{α ( t ) / {s}^{*} + β} = \frac{1}{α ( t ) / ( 8 \cdot {10}^{- 6} \cdot {s}^{*} ) + 1 / C} \qquad ( 10 )$$

and s* can be thought of as the size of the average packet going through the link and also serve as a parameter characterizing efficacy of network elements such as the routers. Our approach works with any model, not just above, having a reasonable number of unknown parameters, which will be referred to as traffic and router characteristic parameters.

Except for, the definition of delay, Equation (10) is consistent with the a theoretical result, which leads (under certain assumptions) to the router queuing delay at time t being approximated by,

$${d}_{q} ( t ) = τ \frac{ρ ( t )}{1 - ρ ( t )} , \qquad ( 11 )$$

where

$$ρ ( t ) = \frac{C - A ( t )}{C} .$$

To see this, rewrite (11) as

$${d}_{q} ( t ) = τ ( \frac{C}{A ( t )} - 1 ) ⇒ A ( t ) = \frac{1}{{d}_{q} ( t ) / ( C \cdot τ ) + 1 / C} \qquad ( 12 )$$

Comparing (10) and (12), if s *=C·π, then the equality of d_{q}(t) and α(t) will result in the equality of Equation (10) and (12). Although α(t) consists of d_{q}(t), dₚ (router processing delay for test packet) and dₗ (link dependent delay), during busy hours, d_{q}(t) is the dominant term. In other words, in busy hours d_{q}(t)≈α(t). Moreover, for all times dₚ is negligible and dₗ is small for a single link, especially links which are not backbones. In applying Equation (12) as opposed to Equation (10) at all times d_{q}(t) can be estimated using α(t), as d_{q}(t)=α(t)−min(α), where min(α) is the parameter estimated using DDmin data. Accurate estimates of min(α) as well as total bandwidth can be obtained using some historical data, and not just the current data set being used for estimating available bandwidth and used bandwidth.

Our used bandwidth estimation method can work with any model with any reasonable number of traffic and router characteristic parameters, that relates the delay to used bandwidth, and not necessarily (10) or (12). To estimate A(t) by our approach, consider for illustration, again Equation (10) and rewrite it as

$$α ( t ) = \frac{8 \cdot {10}^{- 6} \cdot {s}^{*}}{C} ( \frac{C}{A ( t )} - 1 ) = γ ( \frac{C}{A ( t )} - 1 ) , \qquad ( 13 )$$

where

$$γ = \frac{8 \cdot {10}^{- 6} \cdot {s}^{*}}{C}$$

is an unknown parameter. Now we need to estimate this parameter to enable estimation available bandwidth or equivalently the mean traffic rate during a short interval of time around time t. Since this parameter is supposed to be a constant for fairly long period of time, we need to update its estimate only periodically, as opposed to every time we estimate available bandwidth.

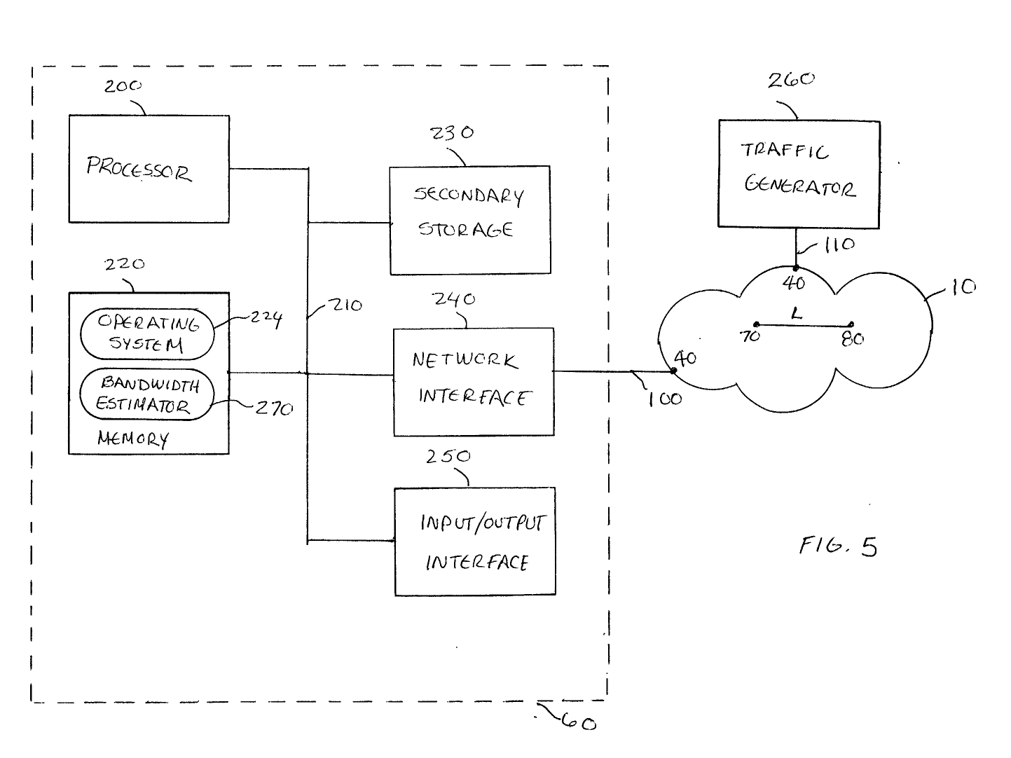

In estimating γ at the beginning and periodically thereafter, it is necessary to collect some delay data during a short time period in which we remotely inject the link with some generated traffic. As illustrated in step 350 of FIG. 4, a known quantity of traffic is generated at various rates rᵢ, i=1, . . . ,m, (step 360 of FIG. 4) and injected to the link within a short period of time to the network when the background traffic is relatively stable. Let the available bandwidth at this time be is some unknown quantity with mean A₀. The injected traffic may be generated by a traffic generator 260 (FIG. 5) which must be on a node physically separate from the remote host. The injected traffic rate rᵢ is also measured in the same unit as A₀—for example in megabits per second. The injection of traffic should be repeated K times within short periods of time. From the methodology described earlier α(t) can be estimated. We can use estimated values α(t) of and model

$${α}_{k} ( t ) = γ ( \frac{C}{{A}_{0} - {r}_{k}} - 1 ) , k = 1 , … , K \qquad ( 14 )$$

to estimate γ and A₀ by a nonlinear regression technique, as in step 370. So

$${s}^{*} = \frac{\hat{γ} \cdot C}{8 \cdot {10}^{- 6}} . \qquad ( 15 )$$

Replace s* in Equation (7) by (12) to obtain

$$\hat{A} ( t ) = \frac{C}{\hat{α} ( t ) / \hat{γ} + 1} \qquad ( 16 )$$

which allows us to estimate available bandwidth Â(t) in step 390 using \hat{α}(t) estimated using equation (8) in step 380 and γ estimated above in step 370.

In collecting the delay data, usage of ICMP packets can be substituted by alternative techniques using TCP (Transmission Control Protocol) or UDP (User Datatgram Protocol) packets. The accuracy of the estimates will depend on the nature of method used to collect the delay data and the formulation of the model. The estimates obtained from our invention can be used to characterize many network-related metrics like traffic rate, bandwidth utilization, etc.

It is assumed that the end-points (nodes) of the Internet hop whose bandwidth is being measured allows ICMP packets to pass through. This is needed as the delay data is obtained from the ICMP packets.

FIG. 5 is a block diagram of an embodiment of a system according to the present invention. Remote monitor host 60 contains a central processing unit or processor 200 which connects via bus 210 to memory 220, secondary storage 230, network interface 240 and input/output (“I/O”) interface 250. Processor 200 executes program instructions resident either in memory 220 or on secondary storage 230 which have been subsequently transferred to memory 220. Memory 220 is generally a random access memory (“RAM”), but may be other types of computer memory, and contains an operating system 224 that enables an end-user to control the flow of data and programs in and between processor 200, secondary storage 230, network interface 240 and input/output interface 250. Memory 220 also contains the bandwidth estimator program 270 which are a coded representation of the methods and algorithms described above. In order to estimate total bandwidth a user would use input/output interface 250 which could be a CRT monitor, keyboard, mouse, printer or other input/output device to tell the operating system 224 to begin a bandwidth estimation. The bandwidth estimator program 270 is then executed in processor 200 causing the steps outlined in FIGS. 3 and 4 to occur depending on whether the selection is total bandwidth (FIG. 3) or available bandwidth (FIG. 4). In a specific implementation discussed above the sets of randomly sized ICMP Echo Request Packets are generated and sent through network interface 240 into the generalized network 10 to nodes 70 and 80 respectively. The nodes 70 and 80 return the echo request and remote host monitor 60 uses the delay data to perform the aforementioned calculations.

Traffic generator 260 which is located outside of the local area network of remote host monitor 60 is used to interject known quantities of traffic necessary to estimate γ necessary in the calculation of estimated available bandwidth. Traffic generator 260 would comprise essentially the same components as remote host monitor 60, i.e., a processor, memory with operating system and traffic generating code, secondary storage, network interface and input/output interface. The remote host monitor 60 and the bandwidth estimation program would send messages to the remotely located traffic generator 260 instructing the traffic generator 260 when and how much traffic to generate.

Remote host 60 and traffic generator 260 can be any device having the necessary components that is identifiable by a network address such as a personal computer, workstation, LAN server, microcomputer, minicomputer or main frame computer.

Secondary storage 230 may include a computer readable medium such as a hard or floppy disk drive, read/write CDROM or tape drive. Secondary storage 230 may be used to store data resulting from execution of the above-referenced bandwidth estimation methods, as well as, the data sets necessary to perform the method. Depending on the size of memory 220 secondary storage may also store parts of operating system 224 and/or bandwidth estimator 270.

Network interface 240 comprises the hardware necessary to communicate with a network such as the Internet and may comprise an Ethernet card, telephone modem, cable modem, T1 line and associated interface or another such communications interface.

Input/Output interface 250 may comprise, for example, a keyboard, mouse and display unit such as a CRT or LCD monitor.

While there has been illustrated and described what are at present considered to be preferred embodiments and methods of the present invention, it will be understood by those skilled in the art that various changes and modifications may be made, and equivalents may be substituted for elements thereof without departing from the true scope of the invention. Therefore, it is intended that this invention not be limited to the particular embodiments and methods disclosed herein, but that the invention include all embodiments falling within the scope of the appended claims.

We claim:

1. A method for estimating the total bandwidth between a first node and a second node in a communications network from a remote host comprising:
generating at the remote host a plurality of randomly-sized data packet pairs each having a first data packet and a second data packet of equivalent size;
sending from the remote host each of said first data packets to said first node;
sending from the remote host each of said second data packets to said second node;
receiving at the remote host a response message from each of said first and second nodes;
generating a set of first delay times indicative of the time each of said first data packets required to reach said first node based on the received response messages;
generating a set of second delay times indicative of the time each of said second data packets required to reach said second node based on the received response messages;
estimating the total bandwidth based on said set of first delay times and said second delay times.
estimating the total hop delay based on said set of first delay times and said second delay times.

2. The method of claim 1 wherein the steps of estimating the total bandwidth and hop delay further comprises the steps of generating a first estimate indicative of the total packet-size independent delay between said first node and said second node and a first estimate indicative of the delay per byte between said first node and said second node using a robust estimation method.

3. The method of claim 2 wherein the first estimate indicative of the total packet-size independent delay, \hat{α}⁰, and the first estimate indicative of the delay per byte, \hat{β}⁰, are generated according to a robust estimation method such as the least trimmed squares robust estimation method using the following relationship:
$$( {\hat{α}}^{0} , {\hat{β}}^{0} ) = {arg min}_{α , β} {\sum }_{i = 1}^{q} ( {r}_{( j )}^{2} ( α , β ) )$$
wherein r₍ⱼ₎²(α,β) is the j^{th} ordered statistics of the squared residuals.

4. The method of claim 2 wherein the step of estimating total hop delay further comprises the step of generating a final estimate of the total packet-size independent delay based on a Bayesian analysis assuming that the first estimate indicative of the delay per byte is correct.

5. The method of claim 4 wherein the Bayesian point analysis further assumes a right-skewed distribution such as the inverse Gaussian delay distribution.

6. The method of claim 5 wherein the Bayesian point analysis for the final estimate of the total packet-size independent delay, α, is determined according to the following relationship:
$$\hat{α} = E ( α \vert {\hat{β}}^{0} , {d}_{\sim} ) = \frac{{\int }_{0}^{∞} {\int }_{0}^{∞} α L ( α , σ \vert {\hat{β}}^{0} , {ⅆ}_{\sim} ) ⅆ σ ⅆ α}{{\int }_{0}^{∞} {\int }_{0}^{∞} L ( α , σ \vert {\hat{β}}^{0} , {ⅆ}_{\sim} ) ⅆ σ ⅆ α}$$
wherein
$$L ( α , σ \vert {\hat{β}}^{0} , {d}_{\sim} ) = {\prod }_{i = 1}^{m} \frac{1}{\sqrt{2 π σ}} {( \frac{μ}{{d}_{i}} )}^{\frac{3}{2}} {ⅇ}^{\frac{1}{2 {σ2}^{{d}_{i}}} {( {d}_{i} - μ )}^{2}} and μ = α + {\hat{β}}^{0} s .$$

7. The method of claim 1 wherein said plurality of randomly-sized data packet pairs is sent more than once to said first node and said second nodes and the set of first delay times and the set of second delay times are based on the minimum delay for each packet size.

8. The method of claim 2 wherein the first and second data packets are ICMP-Echo request data packets.

9. The method of claim 2 wherein the first and second data packets are TCP data packets.

10. The method of claim 2 wherein the first and second data packets are UDP data packets.

11. A method for estimating at a host the available bandwidth as a function of time between a first node and a second node in a communication network comprising the steps of:
generating a known quantity of traffic at a location remote from said host;
injecting said known quantity of traffic into the network;
generating a plurality of randomly-sized data packet pairs each having a first data packet and a second data packet of equivalent size;
sending each of said first data packets from said host to said first node;
sending each of said second data packets from said host to said second node;
receiving a response from each of first and second nodes indicating receipt of said data packets;
generating a set of first delay times indicative of the time each of said first data packets required to reach said first node based on the received response;
generating a set of second delay times indicative of the time each of said second data packets required to reach said second node based on the received response;
estimating the traffic and router characteristic parameters, (γ);
estimating the available bandwidth as a function of time based on said set of first delay times and said second delay times and the average available bandwidth for a short period of time.

12. The method of claim 11 wherein the steps of generating and injecting a known quantity of generated traffic into the network comprises sending K data sets from a traffic generator and the step of estimating the traffic and router characteristic parameters (γ) according to nonlinear regression to solve the following relationship for said K sets of data
$${α}_{k} ( t ) = γ ( \frac{C}{{A}_{0} - {r}_{k}} - 1 ) , k = 1 , … K .$$

13. The method of claim 12 wherein αₖ(t), the estimated bandwidth for data sets K, is estimated in accordance with claim 6.

14. The method of claim 11 wherein the step of estimating the available bandwidth as a function of time based on said set of first delay times and said second delay times and the average available bandwidth for a short period of time is determined by the following relationship,
$$\hat{A} ( t ) = \frac{C}{α ( t ) / \hat{γ} + 1} .$$

15. The method of claim 14 wherein α(t) is estimated for a specific time (t) using a Bayesian point estimate according to the following relationship:
$$\hat{α} = E ( α \vert {\hat{β}}^{0} , \underline{d} ) = \frac{{\int }_{0}^{∞} {\int }_{0}^{∞} α L ( α , σ \vert {\hat{β}}^{0} , {d}_{\sim} ) ⅆ σ ⅆ α}{{\int }_{0}^{∞} {\int }_{0}^{∞} L ( α , σ \vert {\hat{β}}^{0} , {d}_{\sim} ) ⅆ σ ⅆ α} .$$

16. The method of claim 11 wherein the traffic and router characteristic parameters (γ) are re-estimated only upon changes in the network configuration or traffic conditions.

17. A system for the estimation of the bandwidth between two nodes in a communications network comprising:
a memory for storing an operating system and a bandwidth estimator program;
a processor in communication with said memory for executing instructions from said operating system and said bandwidth estimator program;
a network interface for sending and receiving data to and from said nodes in said communications network;
wherein said bandwidth estimator generates a plurality of randomly-sized data packet pairs each having a first data packet and a second data packet of equivalent size, sends said plurality of said first data packets to said first node through said network interface, sends said plurality of said second data packets to said second node through said network interface, receives response a response from each of first and second nodes through said network interface indicating receipt of said data packets, generates a set of first delay times indicative of the time each of said first data packets required to reach said first node, generates a set of second delay times indicative of the time each of said second data packets required to reach said second node and estimates the total bandwidth based on said set of first delay times and said second delay times.

18. The system of claim 17 further comprising a traffic generator for generating and injecting a known quantity of traffic into said network at a location remote from said network interface.

19. The system of claim 18 wherein said bandwidth estimator further comprises means for estimating the traffic and router characteristic parameters (γ) and the available bandwidth as a function of time based on said set of first delay times and said second delay times and the average available bandwidth for a short period of time.

20. The system of claim 17 further comprising an input/output interface for communication with an end-user thereby enabling an end-user to estimate total and available bandwidth between two nodes in a communication network.
